(19) United States
(12) Patent Application Publication
(10) Pub. No.: US 2007/0098229 A1
(43) Pub. Date: May 3, 2007

(54) Method and device for human face detection and recognition used in a preset environment

(76) Inventors: Quen-Zong Wu, Yang-Mei (TW); Heng-Sung Liu, Yang-Mei (TW); Chia-Jung Pai, Yang-Mei (TW)

Correspondence Address: RABIN & BERDO, P.C.;Suite 500, 1101 14th Street, N.W., Washington, DC, 20005, US

(21) Appl. No.: 11/259,264

(22) Filed: Oct. 27, 2005

(51) Int. Cl. G06K 9/00

(52) U.S. Cl. 382/118

(57) ABSTRACT

Disclosed is a method and device for human face detection and recognition used in a preset environment. The human face detection device comprises a camera module, a synchronous image acquiring module, a human face detection module, a human face recognition module and a member face database module. The synchronous image acquiring module is used to acquire synchronously images photographed by the camera module. The human face detection module is used to detect if any human facial feature is presented in the image. If the human facial feature is confirmed, the image is transferred to the human face recognition module to extract the human feature from the image. Then, the extracted human facial feature is compared with member face data stored in the member face database module so that a recognition result which shows a person corresponding to the image is a legal or illegal member is generated.

### BACKGROUND OF THE INVENTION

1. Field of the Invention

The present invention relates to a method and device for human face detection and recognition used in a preset environment. In conducting a human face detection and recognition task, images photographed from different angles are subject to a human face detection process and a human facial feature extract process by using image processing technology and then the extracted human facial feature is determined whether there is a facial feature match corresponding to a specific person in a flexible and integral manner.

2. Description of the Prior Art

In a current human face recognition system, a human face image is photographed at a front side by a camera or a series of human face images are photographed at the front side and one or more human face images are acquired therefrom. Then, the one or more human face images are subject to a human facial feature extract process and the extracted human facial feature is compared with human facial features data stored in a human face image database. Finally, the comparison result is outputted. However, this scheme may not overcome a problem that an invader may attempt to escape from recognition of the camera and recognition system by wearing a mask. A to-be-recognized person may also wear a thick cosmetics or shield a portion of his/her face by changing his/her hair style, thus causing some facial features to disappear and mismatch features image data stored in the database. As such, a wrong determination of human face recognition may be possibly generated. In addition, when the system is used outdoors or in an environment like outdoors, the sunlight may have light change light angle problems and thus cause the human facial feature extract to fail or be erroneous, undesirably reducing a correct human face recognition rate.

In view of these problems encountered in the prior art, the Inventors have paid many efforts in the related research and finally developed successfully a method and device for human face detection and recognition used in a preset environment, which is taken as the present invention.

### SUMMARY OF THE INVENTION

It is, therefore, an object of the present invention to provide a method and device for human face detection and recognition used in a preset environment, in which several camera devices are disposed at front and right and left sides of a human face and front, right and left side human face images are photographed by the camera devices disposed at different angles and then used for detection and recognition of the human face on a mutual aid basis. As such, all human faces from having a normal look, being partially shielded, having cosmetics worn to having a changed hair style may be effectively recognized. Further, correct recognition rate of human face may be promoted and thus guard security purpose may be achieved.

The device for human face detection and recognition comprises a camera module, a synchronous image acquiring module, a human face detection module, a human face recognition module and a member face database module. The camera module contains two or more cameras used to photograph a human face at different angles from the front and right and left sides. The synchronous image acquiring module is used to detect if there is any person entering a detection area by using a dynamic software detection or a hardware detector. When a person is determined as standing at the detection area, the synchronous image acquiring module acquires front and right and left side images of the person synchronously and inputs the front and right and left side images to the human face detection module. In response to the images, the human face detection module analyzes if any human facial feature is presented in the images by referring to the front and right and left images at the same time. If an invader attempts to escape from detection of the human face detection and recognition system by wearing a mask, the right and left side human face is detected as planar and not a human face although his front side human face is detected as a human face. At this time, a warning message is issued by the system to a safety guard and the person is not allowed to pass. Alternatively, the person may be allowed to pass the detection, but needs to be then reviewed by the human face recognition module. In addition, it is possible that the human face detection may be exceptionally performed due to light angle problems taken place when the system is installed at some specific environments. At this time, the right and left side human face images are used for detection aid mutually to determine if there is any side human facial feature. If yes, the human face is subject to a recognition process conducted by the human face recognition module. The human face detection module may generate two results. One is that the person is considered an illegal member and not allowed to pass according to the front and right and left side human face images determined as without a human facial feature presented. The other is that the person is considered as a legal member and allowed to pass since the person is determined as having all or part of human facial features. For the legal member, the front and right and left side human face images are directed to the human face recognition module for recognition where the human facial features are extracted from the front and right and left human face image pair. Then, the extracted human facial features are compared with human face data stored in the member face database module according to a correctness demanding degree set previously. Finally, a result about if the person is a legal member is outputted. Since the method and device may be adjusted in the correctness demanding degree according to real situations, the use of the method and device is highly flexible. Further, since the front and right and left human face images are adopted in the detection process, overall safety and correctness of the bio recognition system may be effectively promoted.

These features and advantages of the present invention will be fully understood and appreciated from the following detailed description of the accompanying drawings.

### BRIEF DESCRIPTION OF THE DRAWINGS

The drawings disclose an illustrative embodiment of the present invention which serves to exemplify the various advantages and objects hereof, and are as follows:

FIG. 1 is a schematic diagram illustrating an application embodiment of a method and device for human face detection and recognition used in a preset environment of the present invention on a bio recognition door guard system; and

FIG. 2 is a flowchart illustrating the method for human face detection and recognition according to an embodiment of the present invention, which is performed by integrally using front, right and left side human face images of a person.

### DETAILED DESCRIPTION OF THE PREFERRED EMBODIMENT

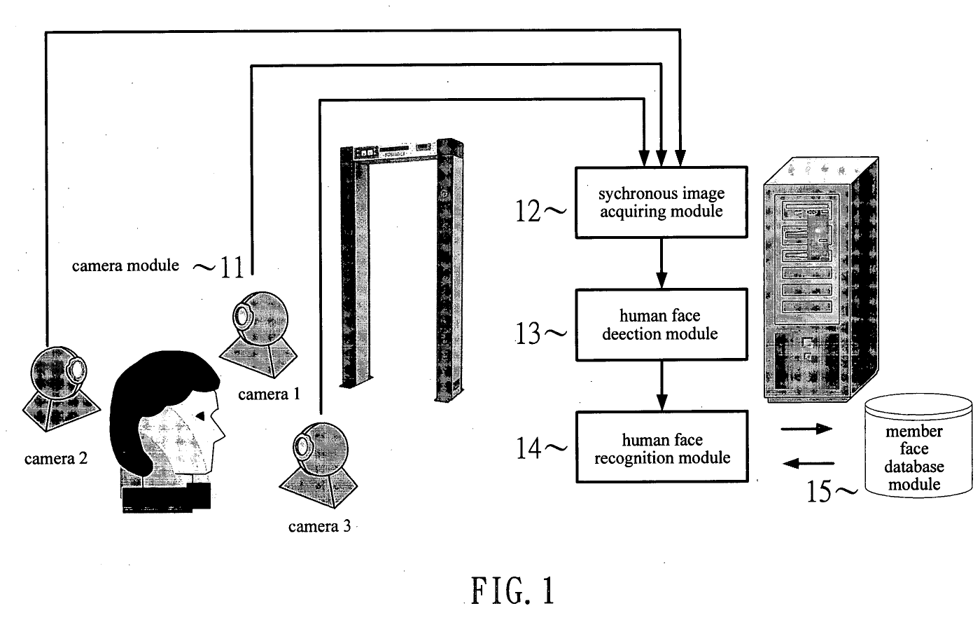

Referring to FIG. 1, a schematic diagram illustrating an application embodiment of a method and device for human face detection and recognition used in a preset environment of the present invention on a bio recognition door guard system is shown therein. The device for human face detection and recognition comprises a camera module 11, a synchronous image acquiring module 12, a human face detection module 13, a human face recognition module 14 and a member face database module 15. The camera module 11 contains three cameras (camera 1, camera 2 and camera 3) used to photograph a human face from a front, right and left side, i.e. three different angles. When the person stands or sits at a predetermined position for human face recognition, the synchronous image acquiring module 12 acquires front, right and left side images synchronously and inputs the front, right and left side images to the human face detection module 13. In response to the images, the human face detection module 13 analyzes if any human facial feature is presented in the images by referring to the front, right and left images at the same time. If a portion or all of the front, right and left images show a human facial feature, the human facial feature is extracted from the image/images. Then, the extracted human facial feature is compared with human face data stored in the member face database module 15 to output a comparison result showing if the person is one of members of a specific group according to a correctness demanding degree set previously.

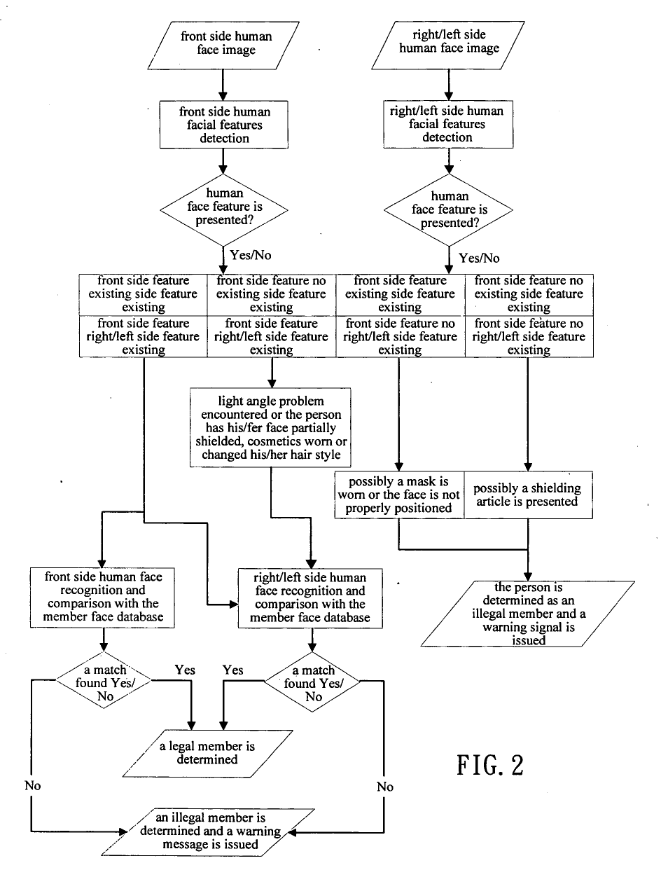

FIG. 2 is a flowchart illustrating the method for human face detection and recognition according to an embodiment of the present invention, which is performed by integrally using the front, right and left side human face images. When a person stands or sits in front of the camera module 11, cameras located at the front side and right and left sides of the person are respectively triggered to photograph the human face of the person. Then, the photographed front, right and left side human face images are detected to see if there is any human facial feature presented. The detection result comprises (1) front side human facial features existing/right and left side human facial features existing, (2) front side human facial features not existing/right and left side human facial features existing, (3) front side human facial features existing/right and left side human facial features not existing and (4) front side human facial features not existing/right and left side human facial features not existing.

If the case (1) occurs, a front side human facial feature extract process and a right and left side human facial feature extract process are performed. The extracted feature is compared with front side and right and left side human facial features image data stored in the member face database module 15. If the extracted feature or any of the extracted features can be found a match in the database 15, the person is taken as a legal member and allowed to pass. Otherwise, the person is considered an illegal member and a warning message is issued to a safety guard.

If the case (2) occurs, only the right and left side human facial feature extract process is performed. Although no front side human face feature is detected, the right and left side human face feature may be used since this may possibly occur when an ambient light angle with respect to the person and the human face detection and recognition device is not proper for human face detection or the person's face is shielded with something, has cosmetics worn or hair style changed. The extract human facial features are compared with the right and left side human facial features image data stored in the member face database. If the comparison result shows a match found in the database, the person is taken as a legal member and allowed to pass. Otherwise, the person is considered an illegal member and a warning message is issued to the safety guard.

If the case (3) occurs, it is considered that the person is an invader, who wearing a mask attempting to escape from detection of the human face detection and recognition device, or the person stands or sits outside a desired range with respect to the camera module. In this case, a warning message is issued to the safety guard.

If the case (4) occurs, it is considered that the person wears a helmet, a mouth mask, sun glasses or other shielding articles when being photographed. In this case, a warning message is issued to the safety guard.

In implementation of such front side and right and left side human face images-integrated human face detection and recognition process, the front side and right and left side human face images may be integrated to a perspective human face image. Then, the perspective human face image is compared with perspective human face image data stored in the member face database 15. If the comparison result shows a match found in the database, the person is considered a legal member and allowed to pass. Otherwise, the person is taken as an illegal member and a warning message is issued to the safety guard.

As compared to the prior art, the method and device for human face detection and recognition provide at least the following advantages. 1. The correctness demanding degree of the human face detection and recognition may be flexibly adjusted according to real situations and the human face detection and recognition process may be proceeded with respect to human faces each having a normal look, being partially shielded, having cosmetics worn, having a changed hair style and the like. 2. An invader may be avoided from passing detection of the human face detection and recognition process. 3. A person may be effectively detected and recognized even when the person wears thick cosmetics, has a changed hair style, has his/her face partially shielded or hurt. 4. The front side and right and left side human face images are used for detection aid mutually to reduce possibility of failed detection due to some problems associated with the ambient light. 5. The cameras located at different angles are not required to be subject to a complex location correctness process as long as they may photograph a complete human face image, effectively promoting installment convenience of the human face detection and recognition device.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A device for human face detection and recognition used in a preset environment, comprising:
a camera module composed of two or more cameras;
a synchronous image acquiring module coupled to the camera module;
a human face detection module coupled to the synchronous image acquiring module;
a human face recognition module coupled to the human face detection module; and
a member face database module coupled to the human face recognition module.

2. A method for human face detection and recognition used in a preset environment, comprising the steps of:
acquiring synchronously human face images photographed from a camera module by a synchronous image acquiring module;
detecting if at least one of the human face images has a human facial feature presented by a human face detection module;
extracting the human facial feature by the human face recognition module if the human face images are determined to have the human facial feature;
comparing the human facial feature to human face data stored in a member face database module; and
outputting a recognition result about if a person corresponding to the human face images is a legal/illegal member.

3. The method according to claim 2, wherein the camera module is composed of two or more cameras disposed at different angles with respect to the person and the human face images are front and right/left side human face images.

4. The method according to claim 2, wherein the synchronous image acquiring module is coupled to the camera module and acquires the human face images synchronously for each human face image acquiring operation so as to reduce an angle difference which the human face images are photographed caused from an instant motion of a human face of the person.

5. The method according to claim 2, wherein the synchronous image acquiring module is triggered to acquire the human face images by dynamically detecting if the person is at a detection area by using the camera module or by detecting if the person is at the detection area by using a hardware sensor.

6. The method according to claim 2, wherein the human face images taken from the different angles are used for detection aid mutually and a correctness demanding degree of the detection and recognition is allowed to be adjusted according to real situations.

7. The method according to claim 2, wherein the front and right and left side human face images are integrated into a perspective human face image, which is compared with perspective human face data stored in the member face database module.
